(19) United States
(12) Patent Application Publication
(10) Pub. No.: US 2019/0098872 A1
(43) Pub. Date: Apr. 4, 2019

(54) Strap Assembly For A Leash

(71) Applicant: Donna Kimmel, Bethesda, MD (US)

(72) Inventor: Donna Kimmel, Bethesda, MD (US)

(21) Appl. No.: 16/003,758

(22) Filed: Jun. 8, 2018

Related U.S. Application Data
(63) Continuation-in-part of application No. 15/732,201, filed on Oct. 4, 2017, now abandoned.

(51) Int. Cl. A01K 27/00

(52) U.S. Cl. CPC A01K 27/003; A45F 2005/006; A01K 27/008

(57) ABSTRACT

A strap assembly for use with a pet leash that enables hands-free management and control of the leash for the user's safety and comfort. The strap assembly comprises a strap with an attachment device that is coplanar with the strap and enables a leash and/or accessory to be coupled to the strap in a perpendicular orientation with respect to the strap. The strap encircles a user's body part and can comfortably provide management of the leash while preventing strain and injury to a user's hands and fingers.

### CROSS-REFERENCE TO RELATED APPLICATION(S)

This application is a continuation-in-part of co-pending application Ser. No. 15/732,201 filed Oct. 4, 2017, the disclosure of which is hereby incorporated by reference.

### BACKGROUND OF THE INVENTION

### 1. Field of the Invention

The present invention relates to a strap assembly for use with a pet leash that will enable hands-free management of the leash for the user's safety and comfort.

### 2. Description of Related Art

Conventional pet leashes or leads must generally be gripped in a user's hand, and have been associated with discomfort and inconvenience for users who have weak and/or injured or partial hands and fingers. Particularly users who walk a large, strong dog or other animal for mutual exercise, pleasure and/or for the animal's elimination, sometimes have pain or discomfort from using a continuous gripping motion with their hands. There are myriad of conditions associated with pain or discomfort in the hands, such as repetitive stress or strain injury, osteoarthritis, neuropathy, rheumatoid arthritis among others which can limit a user's time in walking an animal on a leash. These types of pain and discomfort conditions can be exacerbated by often unpredictable and sudden motions an animal makes while walking which can cause more strain to the leash holder's hand. There are some pet leashes that wrap around a part of the user's chest or waist for hands-free control, but the user could be pulled dangerously off balance by a large or strong animal that may suddenly jerk, pull or run in an unexpected direction. It is desirable to have a safe and effective way to control the animal that eliminates the need to manually grasp or hold a leash tightly with the hands. Moreover, if the experience of walking, jogging or running with a pet is to be fully and truly hands-free, in addition to the hands-free leash control, a hands-free means of carrying used and unused pet waste bags must be available to prevent possible stress, strain or irritation to user's hands and fingers.

### SUMMARY OF THE INVENTION

A strap assembly for use with a conventional pet leash is designed to comfortably encircle and fasten in an adjustable manner to a user's body part. The strap assembly could attach to a user's wrist, forearm, upper arm or the waist to provide hands-free control and management of the leash and leashed animal. In one aspect, the invention provides a strap assembly for a leash comprising a flexible strap having a width dimension and a length dimension to define a plane when laid flat, the strap being of a suitable length for encircling a user's body part. The strap has an adjustable closure to fasten its free ends together around the user's body part. The strap assembly also has a leash attachment device disposed along the length of the strap between its free ends. The leash attachment device is in a planar relationship with the strap when said strap is laid flat and adapted to provide a coupling connection of a leash to the strap assembly such that the leash is disposed in a perpendicular relationship to the strap when the strap is laid flat. The leash attachment device may be co-planar with the strap so as to be in a fixed relationship with respect to the strap instead of free to move independent of the strap.

The attachment device may take different forms such as a ring or carabiner received in a casing in the strap or simply be a double layered strap. A leash and an accessory are coupled to the strap assembly by looping onto the attachment device in a manner that positions the leash and accessory in perpendicular relation to the strap. The planar configuration ensure comfort to the user such that the strap assembly will lay against the user's body part and provide comfortable control without digging or irritation into the skin.

The accessory may be coupled to the attachment device and be provided with attachment tabs to secure the accessory to the leash so that they move together and avoid becoming tangled together. The accessory may be a pouch for stowing pet waste bags, treats, ID, keys, mobile phone, or any other item useful to the user. The strap assembly enables for a completely hands-free experience of managing and controlling the leashed pet to make an outing more enjoyable and strain and pain free for a user with sensitive or injury prone hands and fingers.

Other systems, methods, features and advantages of the invention will be, or will become, apparent to one of ordinary skill in the art upon examination of the following figures and detailed description. It is intended that all such additional systems, methods, features and advantages be included within this description and this summary, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic view of the strap assembly attached to a user and a pet leash in use.

FIG. 2 is a perspective view of the strap assembly attached to a user's wrist and illustrated with a pet leash and pouch attached.

FIG. 3 is a plan view of the strap assembly shown with its free ends and laid flat in a planar format;

FIG. 4 is a close up plan view of an embodiment of the attachment device of the strap assembly.

FIG. 5 is a plan view of the strap assembly, showing the opposite side of the view of FIG. 3, and shown with a leash attached to the leash attachment device.

FIG. 6 is a perspective view of the strap assembly shown with the free ends attached by an adjustable closure.

FIG. 7 is a plan view of the strap assembly, showing an exterior side, with a leash and pouch attached.

FIG. 8 is a plan view of the opposite side of the depiction of FIG. 7, showing an interior side with a leash and pouch attached.

FIG. 9 is a plan view of the pouch as depicted in FIG. 8, but without a leash.

FIG. 10 is a plan view of the rear side of the pouch in isolation shown with the closure flap opened and the attachment tabs open and undone.

FIG. 11 is a close-up view of a portion of an alternative embodiment of the strap assembly showing a construction of the attachment device with a single length of strap material.

FIG. 12 is a plan view of the strap of FIG. 11 shown with a ring in place to form an attachment device.

FIG. 13 is a plan view of the opposite side of the strap of FIG. 12.

FIG. 14 is a close-up view of another embodiment of the strap assembly.

FIG. 15 is a close-up view of another embodiment of the strap assembly.

FIG. 16 is a close-up view of another embodiment of the strap assembly.

FIG. 17 is a plan view of the strap assembly of FIGS. 2-10 illustrated with a cuff.

### DETAILED DESCRIPTION

A strap assembly is designed to encircle a user's body part such as a wrist, an arm or a waist and provides for hands-free management of a pet leash. Any customary loop-handled pet leash can be used in a fully hands-free mode by attaching to the strap assembly thereby entirely eliminating the need for a user to grip the leash loop and preventing any stress or strain to the hands or fingers, especially if weakened or prone to injury. The strap assembly may be used as a wristband, or may be used around the forearm or upper arm of the user. The strap assembly may also be sized to be used around the waist of a user.

In some embodiments, in the wristband use, the wristband slides over the hand but does not freely slide off unless sufficient tension is applied, and/or the user removes it. The adjustable closure of the strap assembly enables it to be loosened for changing from one wrist to another or for removal without undoing the closure completely. In addition, in some embodiments, the strap assembly may have a portion that is elastic to provide some measure of resiliency and dampen the sudden pull on the leash by the leashed animal. Even a light amount of dampening of suddenly applied tension may make the assembly more comfortable for the user or prevent injury.

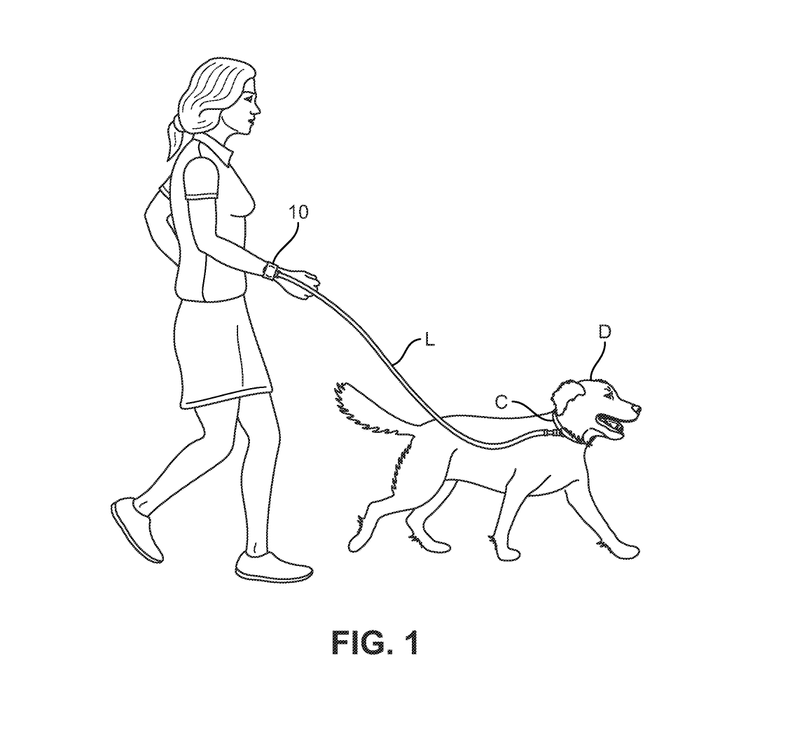

Referring now to the drawings, in FIG. 1, strap assembly 10 is shown encircling a user's wrist. Strap assembly 10 is shown attached to a pet leash L which is a conventional loop-handled leash attached to a pet collar C on a pet dog D. As can be seen in this schematic view, the user's hand is completely freed from handling leash L. For convenience of description, the strap assembly will be described as having an interior side, meaning the side contacting the user's body part, and an exterior side, meaning the side facing outward. However it will be apparent to one of ordinary skill in the art that the strap assembly may be used in any orientation and any use of the structure claimed is within the purview of the claims. Any directional adjectives used herein are for convenient understanding in the context of the embodiments illustrated in the figures, and do not limit the scope of the claims.

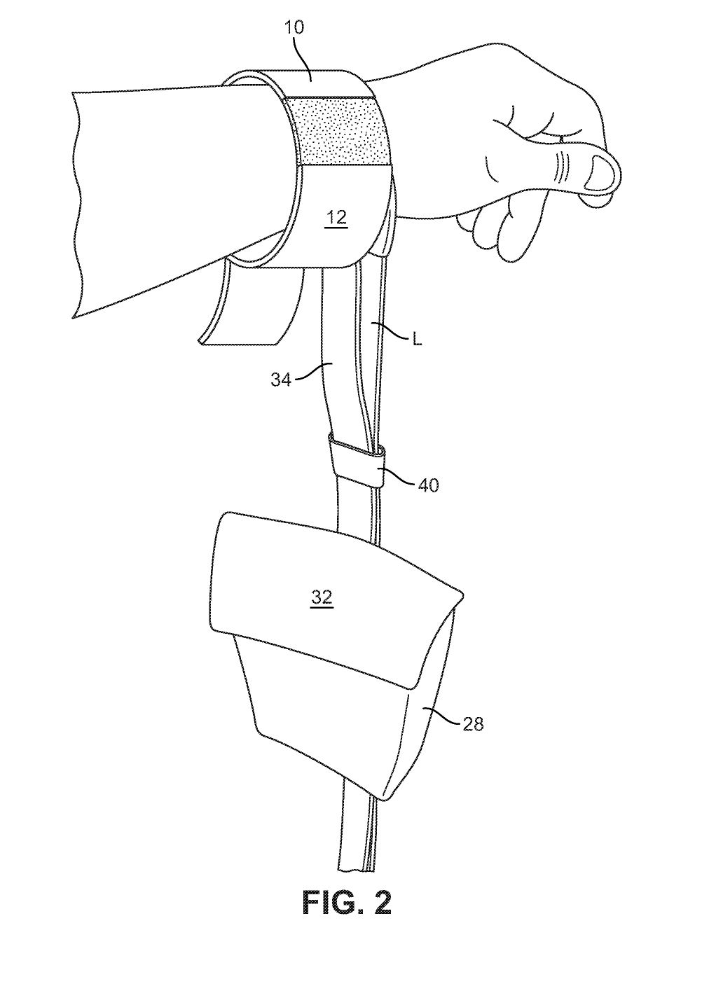

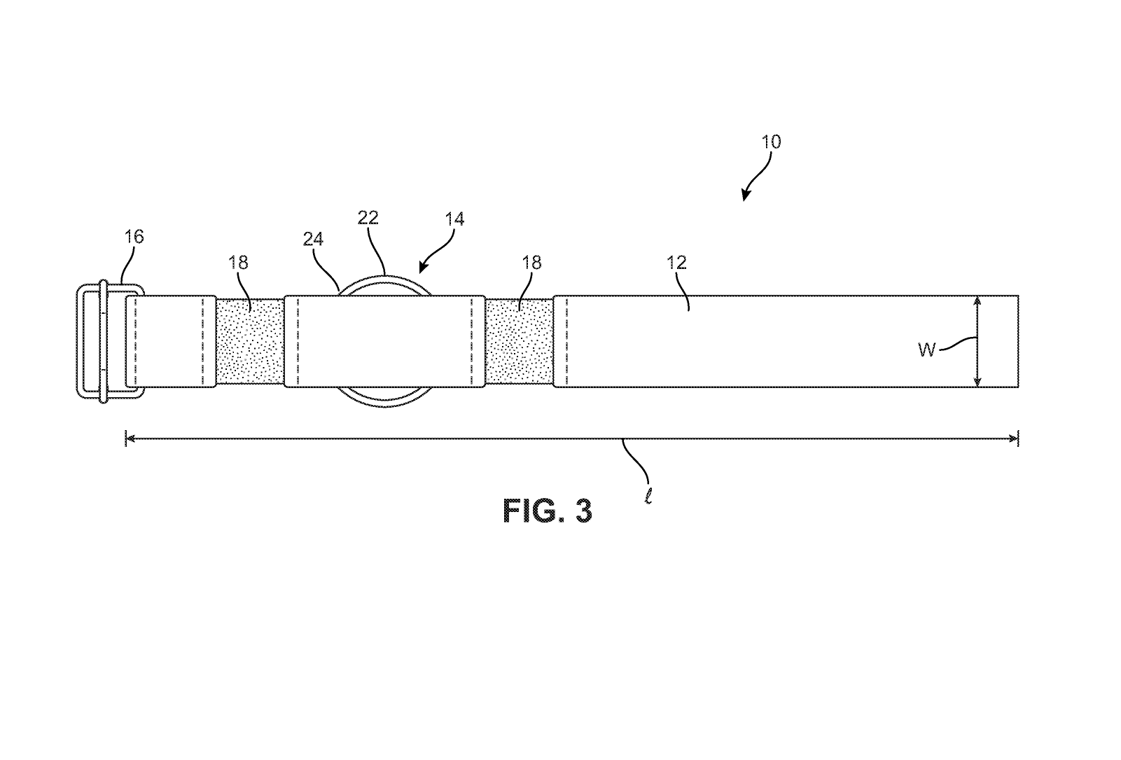

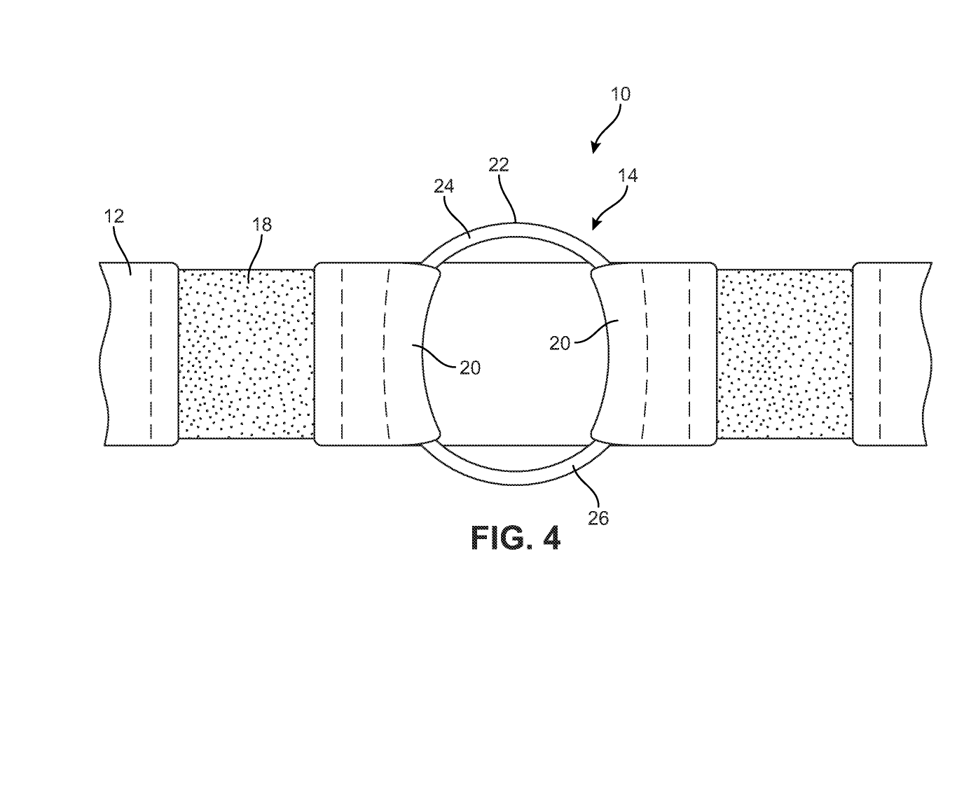

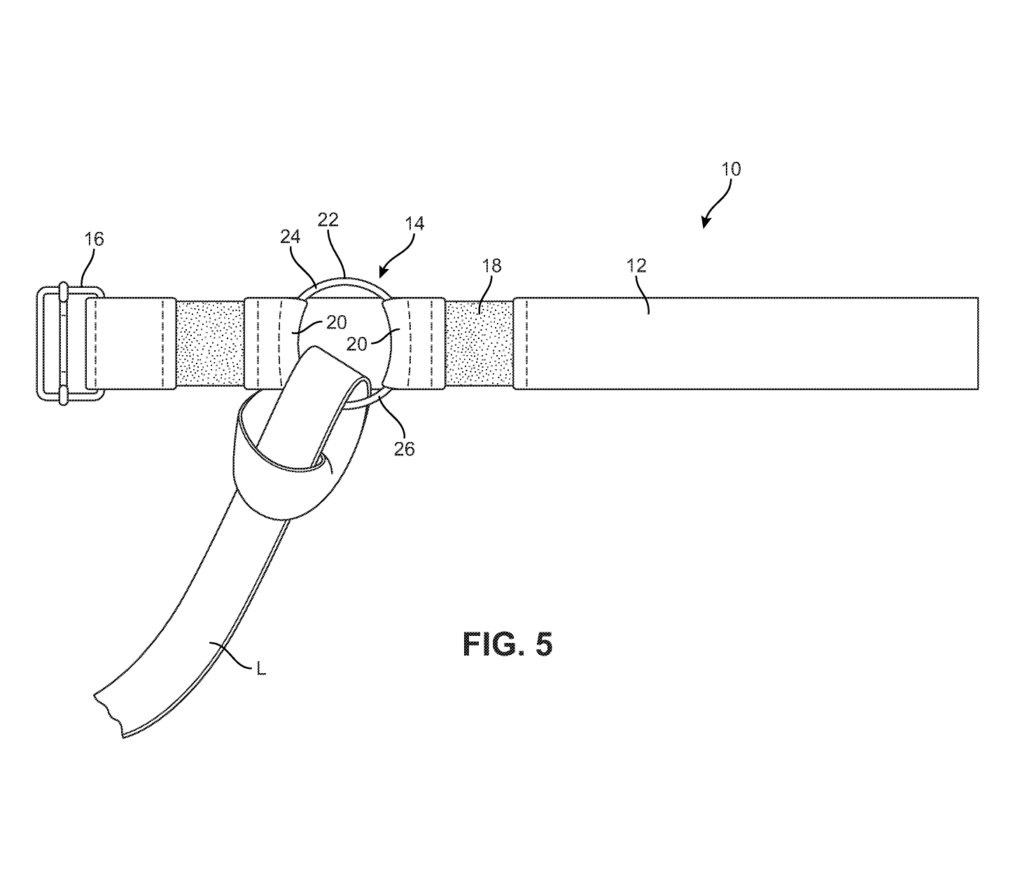

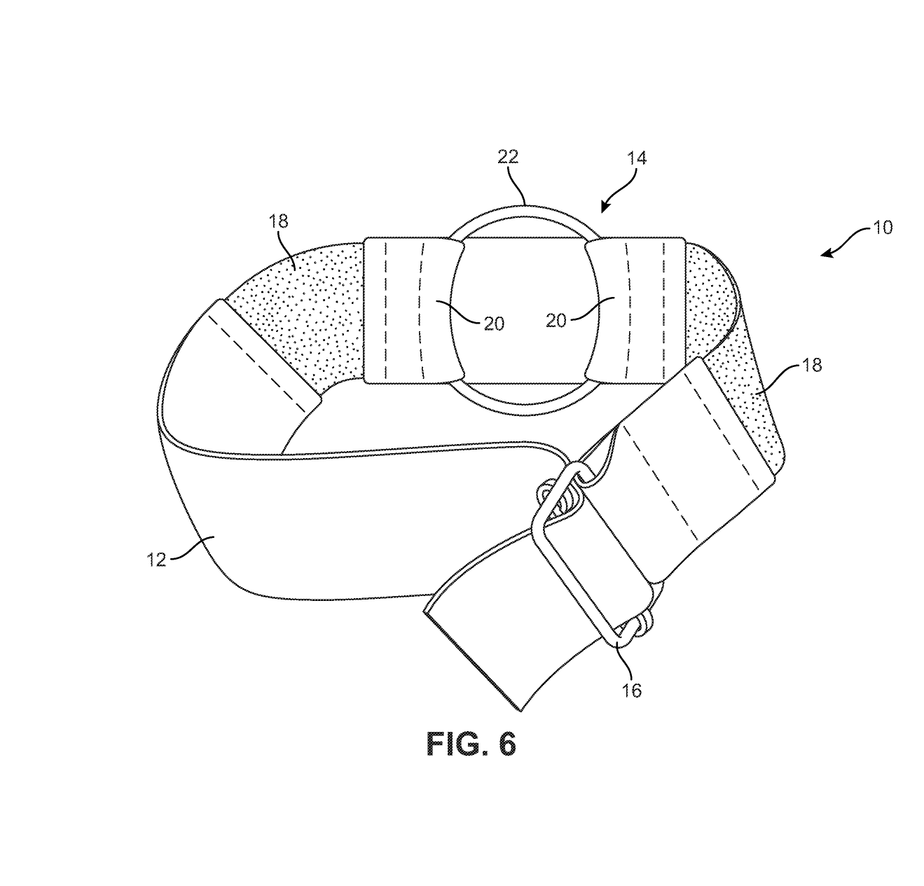

Referring to FIGS. 2-10, a first embodiment of strap assembly 10 is illustrated and comprises a flexible strap 12, a leash attachment device 14, and an adjustable closure 16. For convenient understanding, the side shown in FIG. 3 will be referred to as the exterior side, and the side shown in FIGS. 4-5 will be referred to as the interior side, and it will be understood that a user may apply the strap assembly in the opposite orientation. Strap 12 has free ends which are shown free in FIGS. 3-5 and shown attached to one another by closure 16 in FIG. 6. Strap 12 has a width dimension w and a length dimension £ to have a planar configuration when laid flat as in FIG. 3. This planar configuration provides comfortable contact with the user's body part when the strap assembly is applied and prevents digging or discomfort, especially when tension is applied by the leash. Strap 12 may be formed of a flexible textile material that is woven such as webbing material or the like. Alternatively strap 12 may be made of a sturdier material such as leather or leather-like material, which may or may not be as flexible as a textile material. The Strap 12 may be provided with one or more elastic portions 18 integrated with the strap to provide a measure of dampening of any tension force that may be suddenly applied to the user's body part due to leash pulling or running by the leashed animal. It is also contemplated that the material of strap 12 itself may have elasticity by integrating an elastic yarn, strand or fiber to the material so that it exhibits a measure of elasticity, and therefore dampening, along its entire length.

Strap 12 is constructed with casings 20 on one side for retaining attachment device 14. Casings 20 may be formed of the strap material and constructed with stitches or adhesive or heat sealing appropriate for the strap material. As seen in detail in FIG. 4, casings 20 provide opposing attachment points for attachment device 14, the attachment points being aligned along the length of the strap. While casings 20 are shown in the drawings to be consistent with a fabric casing comprising a folded over or double layered element, it will be understood that the casings may have different configurations to provide opposing attachment points. The casings may be provided by hardware such as rings or clips that hold an attachment device onto the strap. Attachment device 14 is illustrated in the embodiment of FIGS. 2-10 as a ring 22. It is contemplated to be within the scope of the invention for ring 22 to be a closed ring that is sewn into the casings during construction of strap 12. Ring 22 may also be a separable ring comprising a length of wire or the like that is inserted into casings 20 after strap 12 is constructed, and the ring is formed by a closure such as a threaded closure after assembly into the strap casings 20. Ring 22 presents two areas on the strap assembly for attachment of a leash and an accessory.

Closure 16 in FIGS. 2-10 is illustrated as a buckle on one free end of strap 12 for fastening the opposite free end of the strap so as to encircle a user's body part. FIG. 6 illustrates strap 12 with its free ends fastened together. While a slide buckle is the illustrated fastener, it will be understood that any type of adjustable closure suitable for the free ends of a strap may be employed such as, but not limited to, a traditional buckle with prong inserted into holes, a pair of D-rings, mating hook and loop fasteners, a ratcheted closure, a series of mating snaps, catches, carabiners, spring hooks, swivel hooks, cord locks, magnetic clasps or the like. When strap 12 is fastened around a user's body part, the user will have the option of customizing the fit of the strap assembly. An advantage of an adjustable closure is that it can provide a user with a range of fit options including a looser fit so that the strap may be easily removed. When used as a wristband, a user may also opt to fit the strap in a manner that will enable his/her hand to slip out of the closed strap if sufficient tension is applied and the hand narrowed so as to prevent serious injury from sudden tension applied by the leashed animal. In some instances, it may be preferable for the animal to be able to pull free of the user instead of causing the user to fall or pull the user into a more dangerous situation.

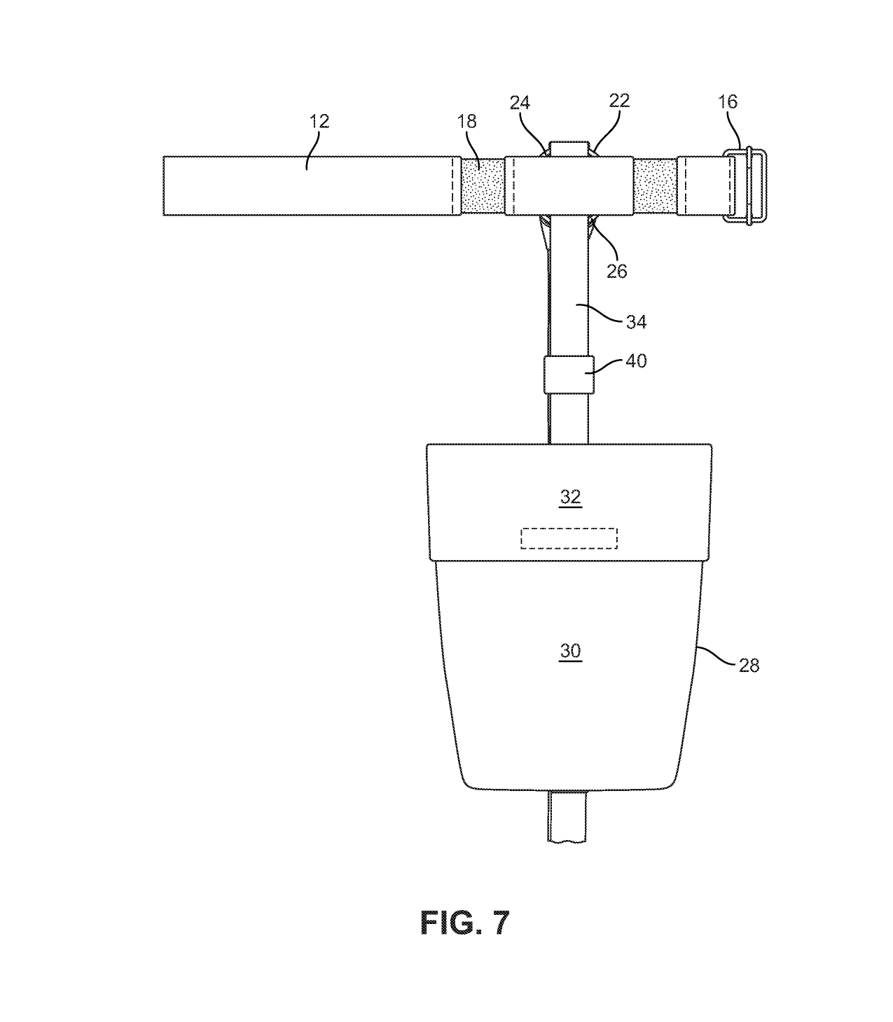

Referring now to FIGS. 4-6, attachment device 14 in this embodiment comprises ring 22 disposed in casings 20 so that attachment device 14 is in a planar relationship with strap 12 when the strap is laid flat. In this fashion, leash attachment device may be said to be co-planar with the strap so as to be in a fixed relationship with respect to the strap instead of free to move independent of the strap. Having ring 22 residing in substantially the same plane as strap 12 affords comfort to the user when the strap assembly is fastened around a user's body part. The strap assembly will rest comfortably flat along the body part to prevent digging, irritation or discomfort. Ring 22 thus situated presents two exposed arcs, illustrated as the top arc 24 and bottom arc 26 of the ring in FIGS. 4-5 which are free from the casings. Arcs 24 and 26 provide ideal attachment points for a leash and an accessory. FIG. 5 illustrates a typical loop-handled leash L that is looped through and attached to the bottom arc 26 of ring 22. When the strap assembly is laid flat, leash L will be in a substantially perpendicular relationship with respect to attachment device 14 and therefore strap 12. This relationship is shown in FIGS. 7-10. Attaching a leash L to strap assembly 10 provides the user with a hands-free mode of control and management of the leashed animal which will prevent overuse injury from having to grip the leash loop, and minimize strain and stress on the user's hands and fingers. In contrast to some typical devices in which a leash can be clipped to a waist belt via a swivel connector, maintaining the attachment device in a fixed, planar relationship to the strap provides a contained device that has no moving pieces and thereby provides more control over the movement of the leash that is attached. Because the leash is attached to the strap assembly in a manner in which the strap and attachment device rest flatly and comfortably on the user's body part, there is no discomfort or irritation even when the leashed animal pulls or changes direction. This enables an outing to be more enjoyable, perhaps longer and better exercise because it would be pain-free for the user with sensitive or weakened hands.

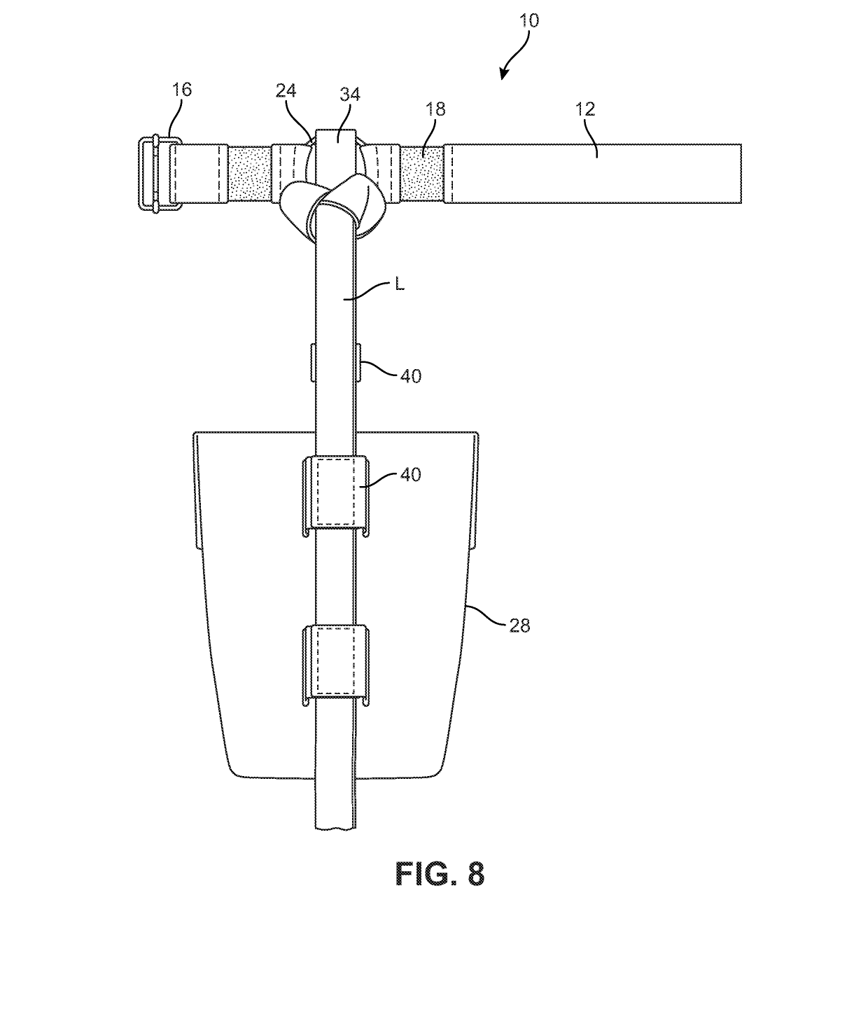

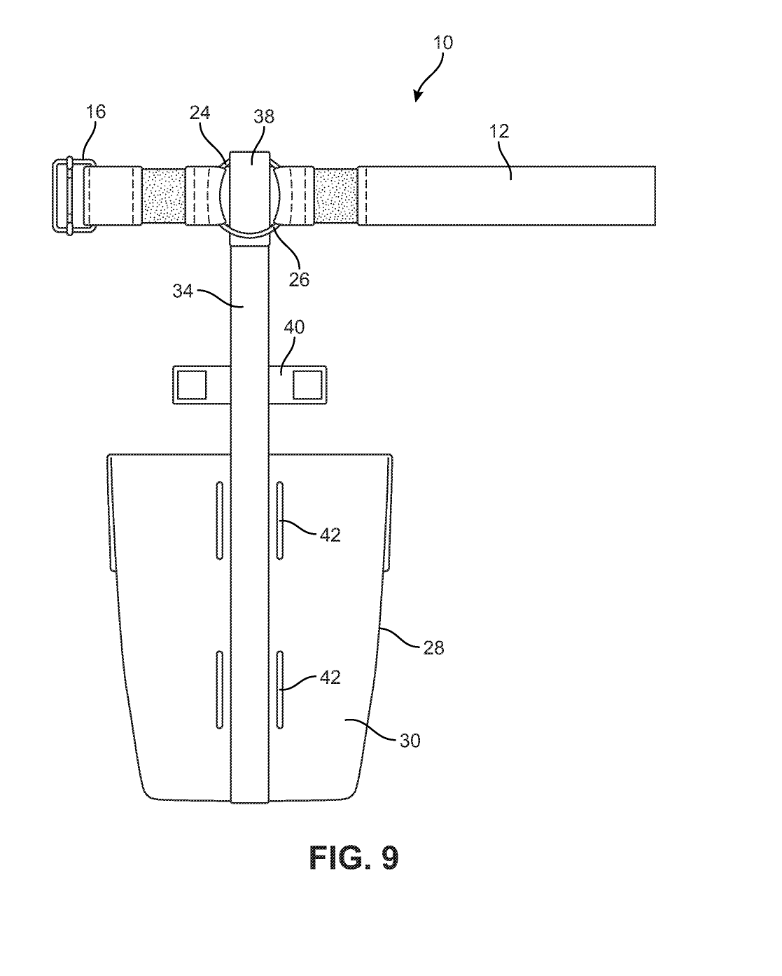

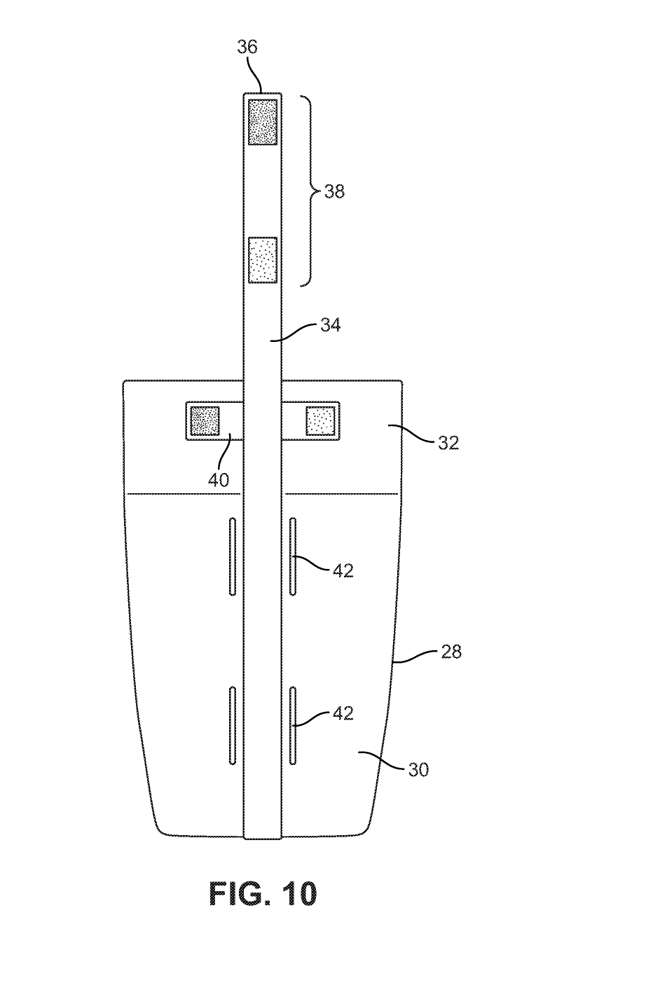

In addition to a leash L, an accessory may also be attached to attachment device 14 by making use of one of the arcs of ring 22. In FIGS. 7-10, the accessory illustrated is an accessory pouch 28. Pouch 28 is designed with a pocket 30 having a closure flap 32 that folds down to secure items carried in pouch 28. Pouch 28 has an attachment strip 34 on one side, the side opposite the closure flap. Pouch strip 34 has a free end 36 which can loop onto arc 24 of ring 22. Pouch strip 34 has a closure 38 associated with its free end 36 which may be some a mating hook and loop fastener to enable free end 36 to loop onto arc 24 and then be secured on itself as in FIG. 8. As seen in the figures, the pouch construction enables its attachment to the strap assembly in a perpendicular relationship when the elements are laid flat as seen in FIG. 8. In order to secure pouch 28 to the entire assembly more securely, pouch strip 34 may be equipped with an attachment element along its length to secure the pouch to a leash where the leash and pouch are coextensive along a length of the leash. Attachment elements could take many forms, and in the illustrated embodiment are shown as securing tabs 40 along its length. Each securing tab may have fasteners, shown in the figures as some sort of mating hook and loop fasteners, which enable pouch 28 to be secured to a length of leash L that is also coupled to attachment device 14. In FIGS. 8-9, the “rear” of the pouch is shown with slots 42 positioned near pouch strip 34. In FIG. 10, closure flap 32 is shown extended so that the pocket would be accessible in that configuration. Slots 42 receive additional securing tabs 40 to secure the pouch strip to a leash L. As seen in FIG. 10, because of the securing tabs 40, when pouch 28 is coupled to the strap assembly and also secured by the pouch strip to a portion of leash L that is also coupled to the strap assembly, pouch 28 is not a free body, but instead is integrated with the leash L so that it does not dangle on its own or get tangled on the leash. This ensures that pouch 28 is secured to and moves with the leash to make it more convenient for the user to manage and will not become tangled with the leash. Other means of attaching pouch 28 to the leash L may be employed in place of the securing tabs, such as directly applied hook and loop fasteners, clasps, snaps, and the like, as long as the pouch is secured to the length of lease L to which it is coextensive, the purpose of having the accessory and lease integrated to move together is accomplished. Pouch 28 may be used for carrying any type of item, such as pet waste bags, new or used, flash light, treats, mobile phone, ID, keys or the like. While pouch 28 is illustrated as a simple one compartment pouch in the drawings, it may have multiple compartments or attachment loops for convenient stowage of any item that a user may find useful. Indeed pouch 28 is simply one type of accessory that could be employed with the strap assembly. A multitude of other types of accessories may be used and attached to the strap assembly, and may be coupled to the attachment device and the leash in various configurations. Having a pouch as part of the kit makes it more convenient for a user to have a completely hands-free experience with their pet.

Depending on the size of animal, and therefore the size of the leash, the strap assembly and an accessory pouch may be scaled accordingly. A strap assembly that could be used for a large animal's leash could be made more robust to accommodate a larger accessory pouch.

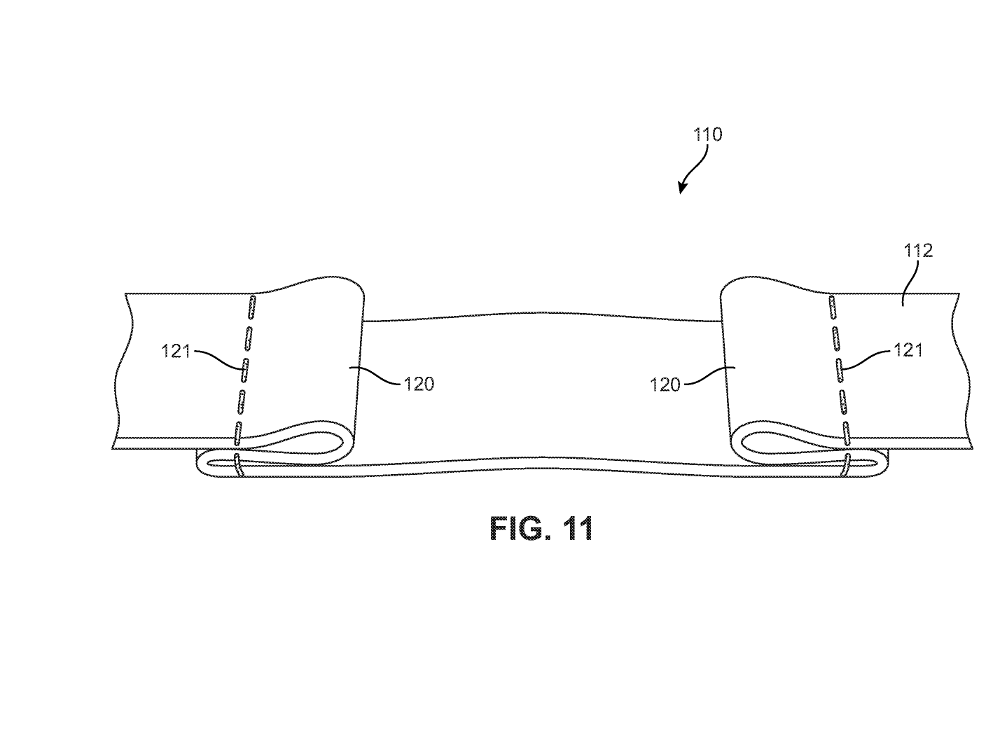

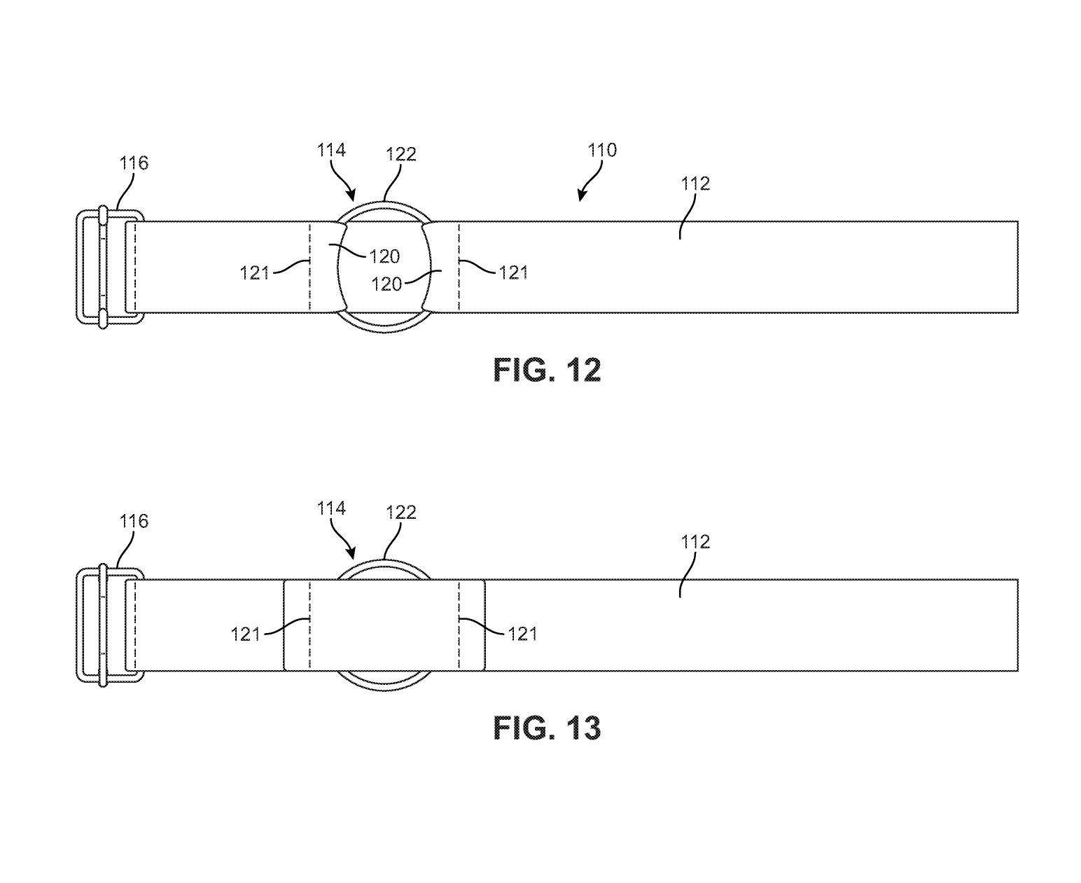

In the strap assembly illustrated in FIGS. 2-10, strap 12 may be constructed of multiple layers of material so that the casings may be formed from separate pieces of material which are then joined to another material to form the strap 12. In another embodiment of the strap assembly of FIGS. 11-13, strap assembly 110 comprises an adjustable closure 116, a strap 112 for which casings 120 are constructed from a single layer of material by stitching 121. The ring is not illustrated in FIG. 11 for clarity, and can be seen in FIGS. 12-13 where it would form an attachment device 114 by insertion into casings 120. Again, the construction is the same in that when laid flat, the strap has a width dimension and a length dimension that provide a planar configuration to comfortably fit around the body part of a user.

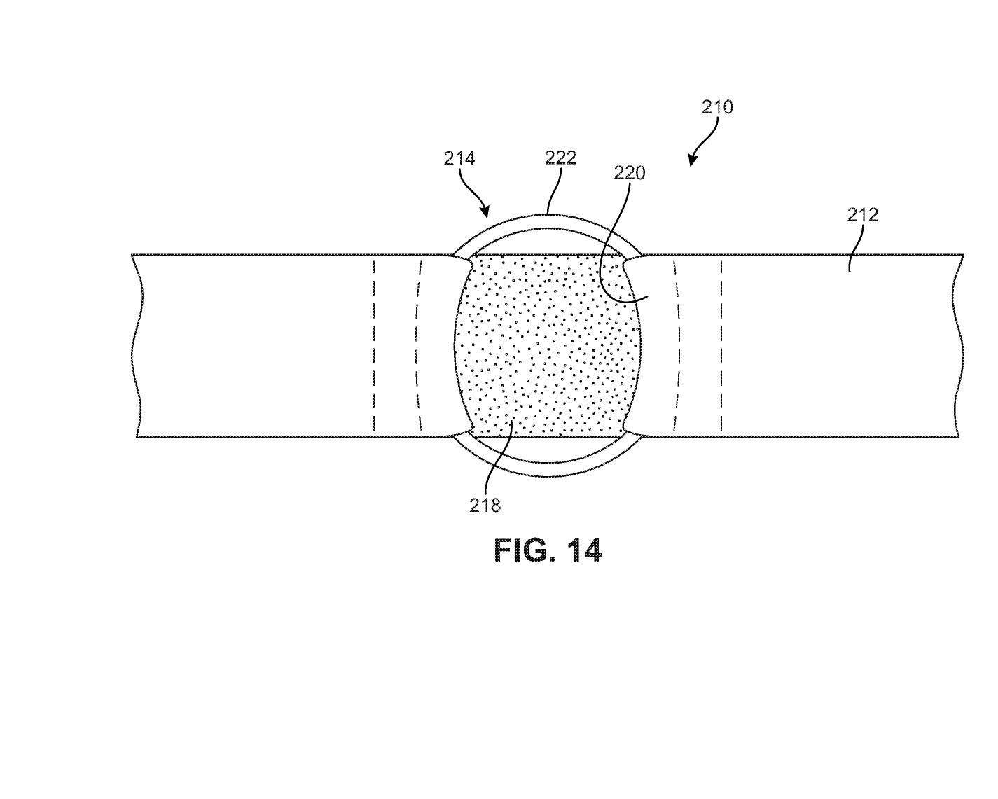

In another embodiment shown in FIG. 14, strap assembly 210 comprises strap 212 and an attachment device 214 which is illustrated to be the ring 222. Ring 222 is inserted into casings 220. In this embodiment, an elastic portion 218 is provided proximate the attachment device 214. As stated previously, elastic portions may be provided anywhere along the length of the strap as well as the strap formed from an elastic material to provide a measure of dampening of the tension force of an animal that pulls on the its leash.

The materials of the strap may be expandable and can be chosen to stretch along the length dimension and be flexible throughout. In one aspect, the expandability and flexibility of the strap may be similar to that of an elastic medical wrap, such as the type commonly used for sprains and strains. The strap may include elastic material sufficient to allow for both expansion to fit around a body part as well as contraction to settle snugly around the circumference of the body part and provide a comfortable, secure way of holding the leash. The material comprising the strap may be sufficiently elastic to enable stretching up to 250% or more without rupture of the overall material and return to its approximate original size. It will be understood that individual filaments, strands, layers or bonds may break when stretched without failure of the overall material. It is also possible that the strap may be largely inelastic to provide a secure attachment.

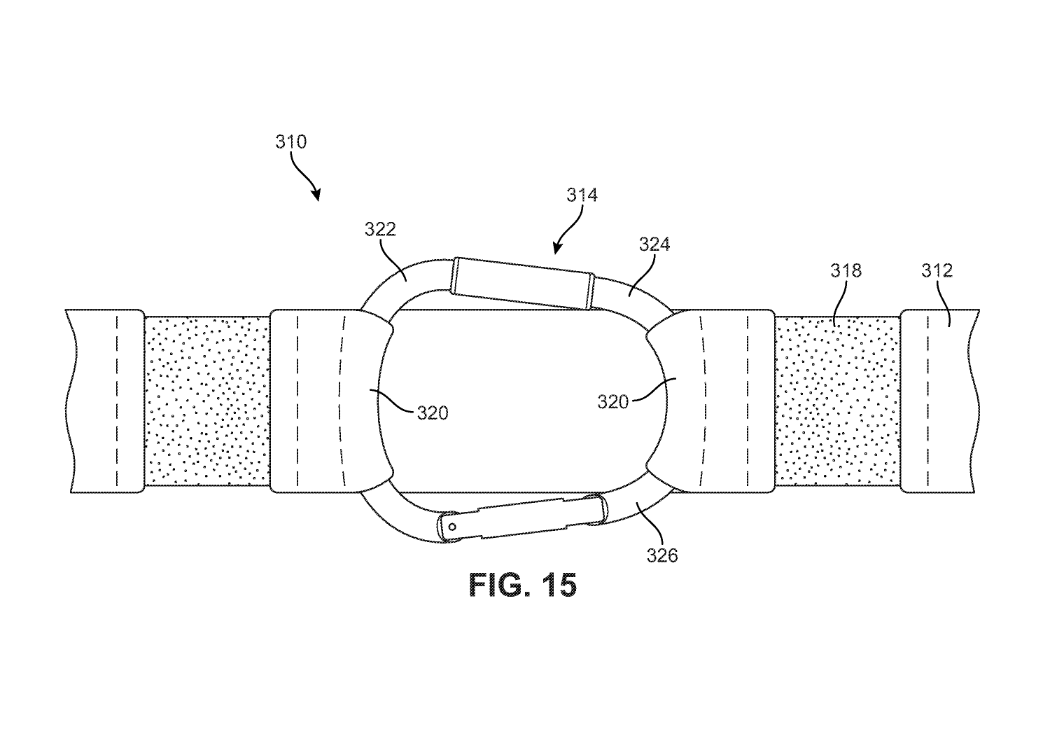

Yet another embodiment shown in FIG. 15, strap assembly 310 comprises strap 312 and attachment device 314. The attachment device in this embodiment may be a carabiner 322 inserted into casings 320 to provide the exposed attachment portions 324 and 326 for a leash and attachment strip. The advantage of a carabiner is easy removal and replacement of this element. Again, this construction also has the same planar configuration of a strap with width and length dimensions substantially defining a plane when laid flat to wrap comfortably around a user's body part. The carabiner embodiment would also enable a leash L and an accessory attachment strip to be in perpendicular relationship to the strap when the assembly is laid flat.

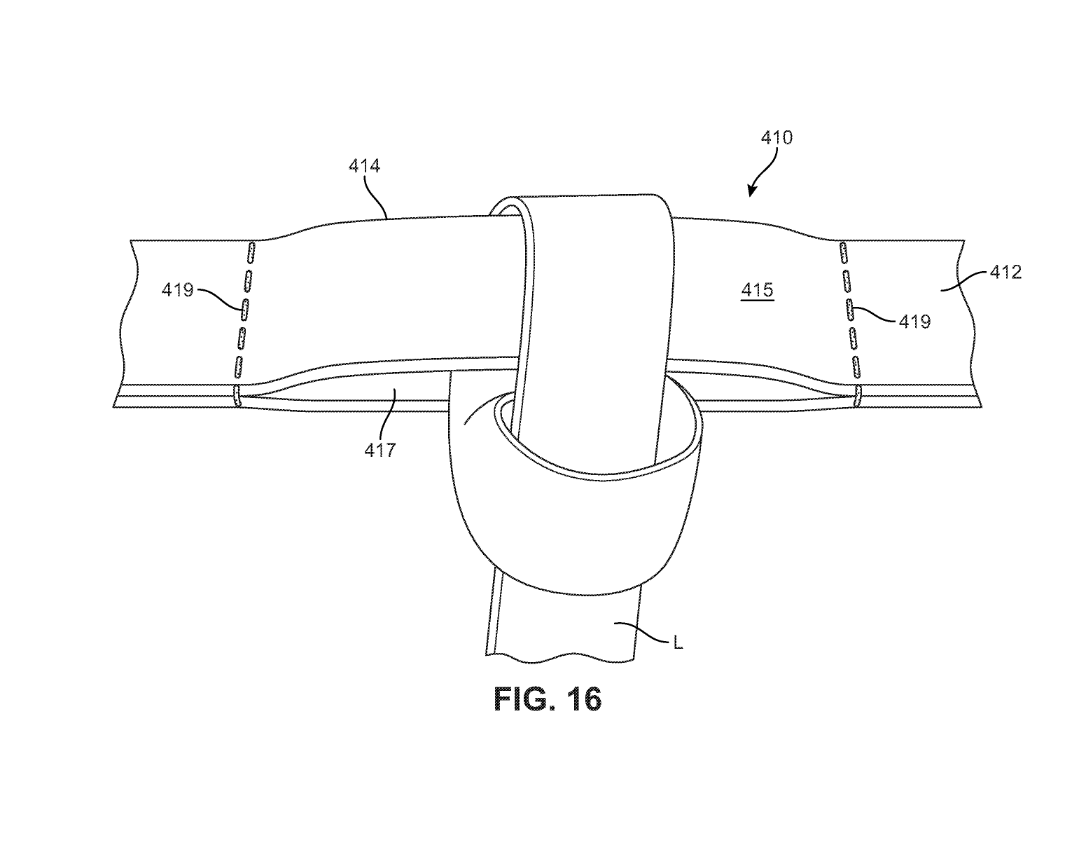

Another possible construction of strap assembly 410 is shown in FIG. 16 in which strap 412 has an attachment device 414 comprising a double layered area. For convenient description, attachment device 414 is illustrated as having an inner layer 415 and an outer layer 417 which are co-extensive with each other and secured by stitching 419. Each layer of the double layer portion may be used to attach a leash L and an attachment strip of an accessory such as a pouch (not illustrated). As can be seen in FIG. 16, strap assembly 410 would also have a width dimension and a length dimension to define a substantially planar configuration when laid flat. Any leash L or accessory attached to attachment device 414 would be in perpendicular relationship to strap 412 when laid flat. Strap assembly 410 would comfortably encircle a user's body part to provide hands-free management and control of the leash and leashed animal.

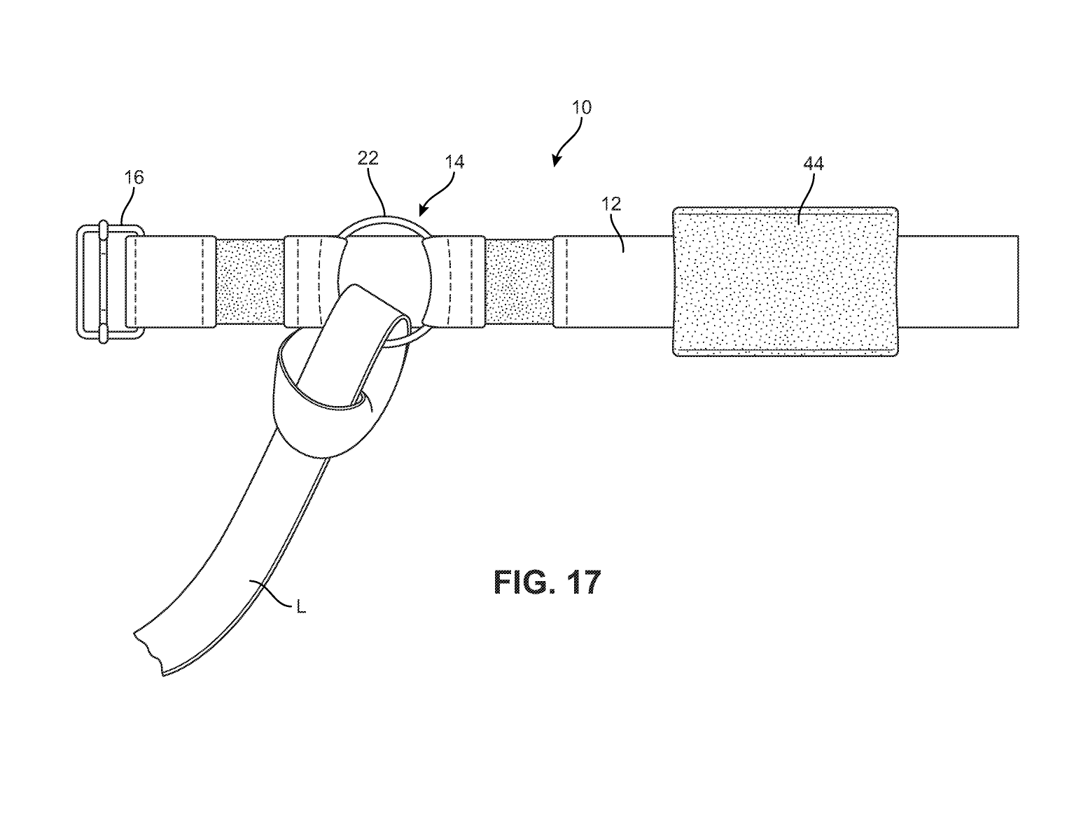

FIG. 17 illustrates a variation that could be applied to any of the embodiments of the strap assembly. For ease of reference, FIG. 17 illustrates the strap assembly of FIGS. 2-10, and includes a cuff 44 attached to a portion of strap 12. Cuff 44 may be a soft material and is intended to receive a user's wrist for more comfort. Cuff 44 may be provided for moisture absorption or other reasons. Cuff 44 may also be the cuff of a glove or mitten (not illustrated) so that the strap assembly provides an integrated hand warmer. The cuff may also provide additional cushioning to the strap and may be sufficiently compressible and soft for comfort. Alternatively, cuff 44 may be a more protective and formed of a more rigid material such as leather, plastic, foam, or the like to provide comfort even if high tensile forces are exerted on the cuff as when a strong animal pulls on a leash or heavy accessories are attached to the strap assembly. For example, if the accessories are heavy such as shopping bags or tools, a more rigid cuff would enable the load to be distributed along the cuff and prevent any digging or irritation of the user's body part.

The construction of the strap assembly may be employed for any application which will relieve a user of the need to grip items and have their hands free. For example, the strap assembly may be configured and sized for a user's waist with plural attachment devices disposed along its length to enable multiple accessories to be coupled to the strap assembly for hands-free carrying of the accessories. To enable easy attachment and detachment of accessories, an auxiliary hook or connector may be used on the attachment device. The accessories may include shopping bags, tools, tool holders, dispensers, or the like. The planar configuration of the strap with the attachment device(s) enable comfortable and secure management or carrying of any number of items. While the strap assembly has been described as being used around a user's body part, it will be understood that the strap assembly could just as easily be fastened around a bar on a wheelchair, stroller or walker. The strap assembly could also be used to secure accessories by securing around any bar, appendage, pole or trunk.

While various embodiments of the invention have been described, the description is intended to be exemplary, rather than limiting and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

1. A strap assembly for a leash comprising:
a flexible strap having a width dimension and a length dimension to define a plane when laid flat, said strap being of a suitable length for encircling a user's body part, said strap having an adjustable closure to fasten free ends of the strap together around the user's body part;
a leash attachment device disposed along the length of said strap between said free ends, said leash attachment device being in a planar relationship with said strap and secured thereto to maintain a fixed planar relationship such that when said strap is laid flat and adapted to provide a coupling connection of a leash to said strap assembly such that the leash is disposed in a perpendicular relationship to said strap when said strap is laid flat, and wherein said leash attachment device and at least a portion of said leash are maintained in a fixed, planar relationship with respect to said strap when said assembly is in use.

2. The strap assembly of claim 1, wherein said leash attachment device comprises a ring disposed in a casing of said strap maintained in a planar relationship with said strap.

3. The strap assembly of claim 1, wherein said leash attachment device comprises a carabiner disposed in a casing of said strap maintained in a planar relationship with said strap.

4. The strap assembly of claim 1, wherein said leash attachment device comprises a double layer area of said strap.

5. The strap assembly of claim 1, wherein said strap includes elasticity along its length.

6. The strap assembly of claim 5, wherein elasticity is provided by an elastic panel attached to said strap.

7. The strap assembly of claim 5, wherein elasticity is provided by an elastic material for said strap.

8. The strap assembly of claim 1, wherein said adjustable closure is a sliding buckle.

9. The strap assembly of claim 1, further comprising a detachable accessory pouch having an attachment strip adapted to be coupled to said attachment device such that said attachment strip would be in perpendicular relation to said strap when said strap is laid flat.

10. The strap assembly of claim 9, wherein said attachment strip of said pouch accessory further comprises an attachment tabs element adapted to secure to a leash such that said pouch accessory and the leash are integrally connected and move together.

11. The strap assembly of claim 10, wherein said accessory is a pouch.

12. The strap assembly of claim 1, further comprising a comfort cuff integrally attached to said strap.

13. A kit for a strap assembly for a leash comprising:
a flexible strap having a width dimension and a length dimension to define a plane when laid flat, said strap being of a suitable length for encircling a user's body part, said strap having an adjustable closure to fasten free ends of the strap together around the user's body part;
a leash attachment device disposed along the length of said strap between said free ends, said leash attachment device being in a planar relationship with said strap and fixedly secured thereto such that when said strap is laid flat and adapted to provide a coupling connection of a leash to said strap assembly such that the leash is disposed in a perpendicular relationship to said strap when said strap is laid flat, and wherein said leash attachment device and at least a portion of said leash are maintained in a fixed, planar relationship with respect to said strap when said assembly is in use;
a detachable accessory adapted to be coupled to the leash and would also be in perpendicular relation to said strap when said strap is laid flat, said accessory comprising an attachment element adapted to secure said accessory to the leash such that said accessory becomes integrated with and moves with the leash.

14. The kit for a strap assembly of claim 13, wherein said leash attachment device comprises a ring disposed in a casing of said strap.

15. The kit for a strap assembly of claim 14, wherein said leash attachment device comprises a carabiner disposed in a casing of said strap.

16. The kit for a strap assembly of claim 14, wherein said leash attachment device comprises a double layer area of said strap.

17. The kit for a strap assembly of claim 14, wherein said strap includes elasticity along its length.

18. The kit for a strap assembly of claim 17, wherein elasticity is provided by an elastic panel attached to said strap.

19. The kit for a strap assembly of claim 18, wherein elasticity is provided by an elastic material for said strap.

20. The kit for a strap assembly of claim 14, wherein said adjustable closure is a sliding buckle.
